(19) United States
(12) Patent Application Publication
(10) Pub. No.: US 2026/0055342 A1
(43) Pub. Date: Feb. 26, 2026

(54) PACKAGED CONTACT LENS

(71) Applicant: CooperVision International Limited, Fareham (GB)

(72) Inventors: Chih-Hao HSU, Fremont, CA (US); Yuwen LIU, Dublin, CA (US); Vicki Anne POOLE, Southampton (GB); Seung Pyo JEONG, Dublin, CA (US)

(73) Assignee: CooperVision International Limited, Fareham (GB)

(21) Appl. No.: 19/091,875

(22) Filed: Mar. 27, 2025

Related U.S. Application Data
(60) Provisional application No. 63/685,357, filed on Aug. 21, 2024.

(51) Int. Cl. C11D 3/00; A45C 11/00

(52) U.S. Cl. CPC C11D 3/0078; A45C 11/005

(57) ABSTRACT

A silicone hydrogel contact lens is described comprising an extractable amount of a hydroxyalkyl cellulose embedded in the silicone hydrogel. The presence of the hydroxyalkyl cellulose in the silicone material improves the wettability of the contact lens.

### FIELD OF THE INVENTION

This application claims the benefit under 35 U.S.C. § 119 (e) of prior U.S. Provisional Patent Application No. 63/685,357, filed Aug. 21, 2024, which is incorporated in its entirety by reference herein.

The field of the invention relates to a silicone hydrogel contact lens having improved wettability. The present invention further relates to contact lens packages that provide improved properties including wettability to the contact lens in the package and further relates to methods to improve one or more properties to the contact lens.

### BACKGROUND

Contact lenses made from silicone hydrogel materials are often preferred over conventional hydrogel materials (i.e. hydrogels that lack a silicone content) because of their superior oxygen permeability, which can be healthier for the cornea. A drawback of silicone hydrogel materials is their hydrophobicity, which can result in a surface that lacks the wettability needed for contact lenses. A contact lens that has low surface wettability can be prone to deposit build-up, which can sometimes lead to discomfort.

Various approaches have been taken to increase the surface wettability of silicone hydrogel contact lenses including the use of custom siloxane monomers that have hydrophilic groups, plasma-treatment of the lens surface, and attachment of hydrophilic coatings.

Additional approaches for enhancing the wettability of silicone hydrogel contact lenses that do not require the need for expensive custom siloxanes or extra manufacturing steps would be useful.

### SUMMARY

A feature of the present invention is to provide a packaging solution that can increase the wettability of a silicone hydrogel contact lens in the packaging solution.

A further feature of the present invention is to provide a contact lens package that can increase the wettability of the contact lens present.

A further feature of the present invention is to provide a contact lens package that can decrease the sessile drop contact angle of the contact lens present.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention, in part relates to a autoclaved contact lens package comprising: (a) a packaging solution comprising a hydroxyalkyl cellulose and optionally at least one surfactant, and (b) a contact lens immersed in the packaging solution, wherein the contact lens comprises a silicone hydrogel and an extractable amount of the hydroxyalkyl cellulose embedded in the silicone hydrogel.

In one example, the hydroxyalkyl cellulose is hydroxyethyl cellulose or hydroxypropyl methylcellulose, or a combination of both hydroxyethyl cellulose and hydroxypropyl methylcellulose.

Unless stated otherwise, all % are weight % and are based on the total weight of the composition or solution.

The accompanying drawings are incorporated in and constitute a part of this application and illustrate some of the features of the present invention. The drawings, together with the description, serve to explain the principles of the present invention.

### BRIEF DESCRIPTION OF THE DRAWING

FIG. 1A depicts tubes (one before and one after heating) containing a homogenous solution comprising aqueous saline with hydroxyethyl cellulose (HEC), with the tube on right heated to a temperature of 121° C. and the tube on the left shown before heating.

FIG. 1B shows the structure of HEC.

FIG. 1C depicts the hypothesis that the HEC molecule forms intramolecular hydrogen bonds above its LCST resulting in a hairpin-like or globular conformation that exposes the hydrophobic backbone of HEC, which in turn results in its phase separation from water.

FIG. 2A depicts a contact lens package of the invention prior to autoclave.

FIG. 2B depicts a contact lens package of the invention during autoclave.

FIG. 2C depicts an autoclaved contact lens package of the present invention.

### DETAILED DESCRIPTION

A contact lens package comprising a silicone hydrogel contact lens immersed in a packaging solution is described herein. The silicone hydrogel contact lens comprises an embedded hydroxyalkyl cellulose that preferably provides the contact lens with improved wettability. Also described herein is a contact lens that has embedded hydroxyalkyl cellulose that preferably provides the contact lens with improved wettability. Methods of manufacturing the contact lens package are further described herein. Also, methods to improve the wettability of a contact lens, such as a silicone hydrogel contact lens, are described herein.

The contact lens comprises a silicone hydrogel that is formed by conventional cast molding methods where a polymerizable composition comprising at least one silicone monomer and at least one hydrophilic monomer is dispensed into a contact lens mold and subjected to conditions that cure the polymerizable composition. The resulting cured polymer is removed from its mold, extracted to remove some or all of the unreacted components, and hydrated to form a silicone hydrogel. Polymerizable compositions and methods for forming the silicone hydrogel are described in more detail below. The contact lens, as described herein, that comprises a silicone hydrogel can be considered a silicone hydrogel contact lens for purposes of the present invention.

The packaging solution comprises at least a hydroxyalkyl cellulose. The packaging solution can comprise a buffered saline solution and a hydroxyalkyl cellulose. The packaging solution can comprise a buffered saline solution, a surfactant, and a hydroxyalkyl cellulose. More than one type of buffered saline solution, and/or more than one type of surfactant, and/or more than one type of hydroxyalkyl cellulose can be present in the packaging solution.

Examples of hydroxyalkyl celluloses include hydroxyethyl cellulose (HEC), hydroxypropyl methylcellulose (HPMC), hydroxypropyl cellulose, ethyl hydroxyethyl cellulose, and/or methyl ethyl hydroxyethyl cellulose.

Hydroxyalkyl celluloses such as HEC and HPMC increase the viscosity of contact lens packaging solutions. For succinctness, the invention will be hereinafter described with reference to HEC as the hydroxyalkyl cellulose, however it should be understood that HPMC or other hydroxyalkyl celluloses can be used in place of HEC.

HEC was added to the packaging solution of contact lenses made from somofilcon A in order to increase the viscosity of the packaging solution. Surprisingly, the viscosity of the packaging solution dropped significantly after autoclave. Experimentation was undertaken to try to understand the cause of the viscosity drop.

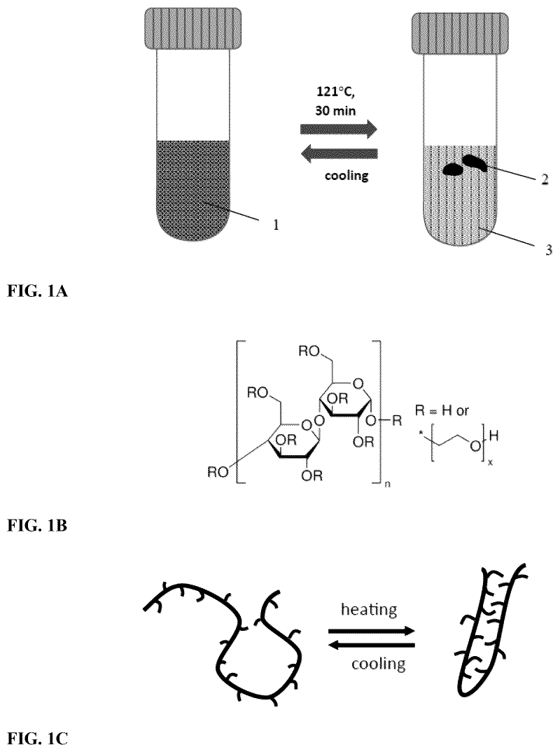

It was found that only a slight drop in viscosity occurs when the packaging solution is autoclaved without a silicone hydrogel contact lens present. When an HEC-packaging solution was heated in clear vials to a temperature of 121° C. without the presence of a contact lens, phase separation was observed. When the solution was cooled it became homogenous again. This phenomenon can be explained by the lowest critical solution temperature (LCST) of HEC being exceeded during autoclave, which causes a phase separation into viscous HEC polymer-rich domains and solvent-rich domains (i.e., water-rich domains). This is depicted in FIG. 1A, which shows a tube containing a homogenous solution, 1, comprising aqueous saline with HEC. When the tube is heated to a temperature of 121° C., HEC-rich domains, 2, form while the remaining solution can be considered a water-rich domain, 3, having a lower concentration of HEC than the pre-heated solution, 1. As the contents of the tube cools the solution becomes homogenous again.

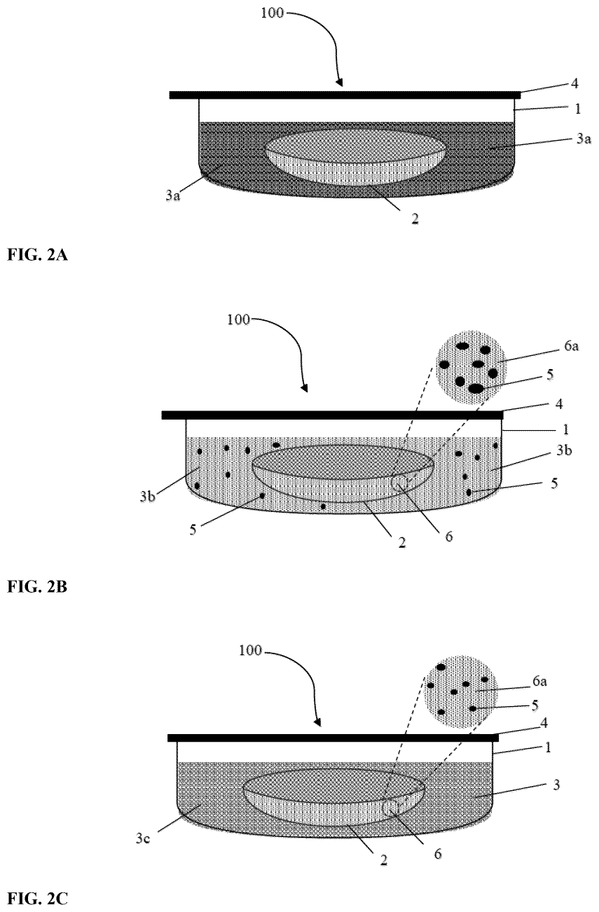

FIG. 1B shows the structure of HEC. FIG. 1C depicts the hypothesis that the HEC molecule forms intramolecular hydrogen bonds above its LCST resulting in a hairpin-like or globular conformation that exposes the hydrophobic backbone of HEC, which in turn results in its phase separation from water. It is hypothesized that through hydrophobic interactions, a silicone hydrogel contact lens can take up HEC when the HEC is in a globular conformation. Upon cooling, a portion of the HEC remains embedded within the silicone hydrogel material such that the packaging solution in which the contact lens is immersed has a lower concentration of HEC and, hence, lower viscosity, than that of the pre-autoclave packaging solution. This hypothesis is depicted in FIG. 2A through FIG. 2C. FIG. 2A depicts a contact lens package, 100, prior to autoclave. The contact lens package comprises a container, 1, a packaging solution, 3a, comprising HEC, a silicone hydrogel contact lens, 2, immersed in the packaging solution, and a removable cover, 4, adhered to the container by a liquid-impermeable seal. Referring to FIG. 2B, during autoclave the temperature exceeds the LCST of HEC resulting in phase separation of the packaging solution into viscous HEC-rich domains, 5, and a water-rich domain, 3b. The silicone hydrogel contact lens, 2, absorbs some of the HEC-rich domains, 5, as depicted in the magnification, 6a, of a portion, 6, of the silicone hydrogel contact lens delineated by a dotted circle. As depicted in FIG. 2C, once the contents of the contact lens package cool after autoclave the packaging solution, 3c, is homogenous and there is no more phase separation. At least some of the HEC, 5, that was absorbed by the silicone hydrogel contact lens, 2, during autoclave remains associated with the contact lens as depicted in the magnification, 6a, of a portion, 6, of the silicone hydrogel contact lens delineated by a dotted circle. Consequently, the post-autoclave packaging solution, 3c, has a lower concentration of HEC compared to the pre-autoclave packaging solution, 3a, and, hence, a lower viscosity.

Further experimentation revealed that silicone hydrogel materials that have relatively low surface wettability took up higher amounts of HEC from the packaging solution during autoclave compared to a silicone hydrogel contact lens material having high surface wettability.

When the packaging solution included a surfactant, the wettability of the lenses that took up greater amounts of HEC increased even more, whereas the wettability of the lenses that took up relatively little HEC during autoclave stayed the same, or about the same, or even decreased. These experiments are described in more detail in Examples 5 and 6 below.

Accordingly, the present invention is based on the discovery that silicone hydrogel contact lenses are capable of absorbing substantial amounts of HEC from an HEC-containing packaging solution during autoclave, which results in significant improvement in surface wettability, whereas silicone hydrogel contact lenses that are already highly wettable as well as non-silicone hydrogel contact lenses absorbed significantly less HEC when autoclaved in the same HEC-containing packaging solution and exhibited no improvement in surface wettability.

As indicated, the above details and results relating to the findings of HEC when autoclaved in the presence of a silicone hydrogel contact lens are applicable to other hydroxyalkyl celluloses, as described herein.

Based on the foregoing discoveries and observations, the present invention provides an autoclaved contact lens package comprising: (a) a packaging solution comprising a hydroxyalkyl cellulose and optionally a surfactant; and (b) a contact lens immersed in the packaging solution, wherein the contact lens comprises a silicone hydrogel and an extractable amount of the hydroxyalkyl cellulose embedded in the silicone hydrogel. In some embodiments, the contact lens of the contact lens package has a sessile drop contact angle that is equal to or lower than the sessile drop of a control contact lens that is autoclaved in a packaging solution that lacks the hydroxyalkyl cellulose. It will be understood that the term “control” in this context means that the method of manufacturing, packaging, and autoclaving the control contact lens is identical to that of the contact lens of the contact lens package of the invention except that the hydroxyalkyl cellulose is not included in the packaging solution and therefore the ‘control contact lens’ has no hydroxyalkyl cellulose embedded therein.

The hydroxyalkyl cellulose is added to the packaging solution in an amount to provide the packaging solution with a pre-autoclave viscosity of from about 1.5 centipoise (cP) to about 15.0 cP, such as from about 2.0 cP to 10.0 cP, or from about 2.5 cP to 8.0 cP, where viscosity is determined at 25° C. (1 atm) and shear rate=10 [1/s] using a Physica MCR 301 model rheometer from Anton Paar or equivalent method. As previously described, the viscosity of the packaging solution of the contact lens package of the present invention drops after autoclave due to uptake of the hydroxyalkyl cellulose by the silicone hydrogel material. In some examples, the packaging solution has a pre-autoclave viscosity that is at least 20% more (i.e. higher) than the post-autoclave viscosity. In some examples, the viscosity of the packaging solution prior to autoclave is at least 25% more or at least 30% more than the viscosity of the packaging solution after autoclave. The packaging solution of the autoclaved contact lens package of the invention preferably has a viscosity of at least 1.5 cP, or at least 2.0 cP, or at least 2.5 cP, or at least 3.0 cP, such as from 1.5 cP to 12 cP or from 2.0 cP to 12 cP, or from 2.5 cP to 12 cP, or from 3.0 cP to 12 cP.

The viscosity of the packaging solution depends on the hydroxyalkyl cellulose used, the amount used, and its molecular weight, as shown in Table 4 below. In one example, the hydroxyalkyl cellulose is HEC having a number average molecular weight of about 100 kDa to 1200 kDa, or about 250 kDa to 750 kDa. The packaging solution typically comprises from about 0.001 wt. % up to about 5.0 wt. % of the hydroxyalkyl cellulose, or from about 0.01 wt. % up to about 1.0 wt. % of the hydroxyalkyl cellulose, based on the total wt % of the packaging solution prior to any contact lens being present and prior to any autoclaving of the packaging solution. It will be appreciated that the concentration of the hydroxyalkyl cellulose in the packaging solution when it is prepared will be greater than the concentration of the hydroxyalkyl cellulose in the packaging solution of the autoclaved contact lens package due to uptake of some of the hydroxyalkyl cellulose by the silicone hydrogel. In one example, the packaging solution of the autoclaved contact lens package comprises HEC in an amount of about 0.05 wt. % to about 1.0 wt. %. In a specific example the packaging solution of the autoclaved contact lens package comprises about 0.1 wt. % to about 0.75 wt. % HEC having a molecular weight of about 250 kDa to 750 kDa.

As described previously, the addition of a surfactant in the packaging solution can facilitate increased uptake of the hydroxyalkyl cellulose by the silicone hydrogel during autoclave. The amount of surfactant in the packaging solution is typically from about 0.001 wt. % to about 0.5 wt. % based on the total weight of the packaging solution prior to any contact lens being present and prior to any autoclaving of the packaging solution.

In one example, the surfactant is a poloxamer, such as Poloxamer 407 (CAS No. 691397-13-4). In a specific example, the packaging solution comprises from about 0.005 wt. % to about 0.05 wt. % poloxamer.

In another example, the surfactant is a polysorbate surfactant, such as Tween 80 (CAS No. 9005-65-6). In a specific example, the packaging solution comprises from about 0.001% to about 0.01% of a polysorbate surfactant. Other suitable surfactants will be apparent to those skilled in the art.

The packaging solution can comprise a buffer to maintain an ophthalmically-acceptable pH in the range of about 6.0 to about 8.0, preferably from about 7.0 to about 7.8, and more preferably from about 7.2 to about 7.4. Numerous buffering agents suitable for ophthalmic use are well-known in the field. In one example, the packaging solution comprises phosphate buffer or borate buffer.

The packaging solution can also comprise a tonicity agent in an amount sufficient to maintain an ophthalmically-acceptable osmolality in the range of about 200 to 500 mOsm/kg, and typically from about 270 mOsm/kg up to about 360 mOsm/kg. Numerous tonicity agents suitable for ophthalmic use are well-known in the field. In one example, the packaging solution comprises sodium chloride and/or sorbitol.

The contact lens of the invention comprises a silicone hydrogel. Silicone hydrogel contact lenses are typically formed by curing a polymerizable composition (i.e., a monomer mixture) comprising at least one siloxane monomer and at least one hydrophilic monomer. As used herein, the term “siloxane monomer” refers to a molecule that contains at least one Si—O group and at least one polymerizable functional group. The term “monomer” refers to any molecule containing a functional group capable of reacting with other monomers during curing conditions to form a polymer. Thus, as used herein, the term “monomer” has no size-constraint and encompasses macromers and pre-polymers.

Siloxane monomers suitable for use in contact lens formulations are well-known in the art. Exemplary siloxane monomers are listed in the USAN (United States Adopted Names) listings for various commercial silicone hydrogel contact lenses. Examples include the USANs for comfilcon A, fanfilcon A, stenfilcon A, senofilcon A, senofilcon C. somofilcon A, narafilcon A, delefilcon A, narafilcon A, lotrafilcon A, lotrafilcon B, balafilcon A, samfilcon A, galyfilcon A, and asmofilcon A.

In some examples, the polymerizable composition comprises a total amount of siloxane monomer of at least 10 wt. %, 20 wt. %, or 30 wt. % up to about 40 wt. %, 50 wt. %, 60 wt. %, or 70 wt. %. Unless specified otherwise, as used herein, a given weight percentage (wt. %) of a component of a polymerizable composition is relative to the total weight of all ingredients that are incorporated into the final silicone hydrogel material. The weight of the polymerizable composition contributed by components such as diluents that do not incorporate into the final contact lens product are not included in the wt. % calculation.

In a specific example, the polymerizable composition comprises a hydrophilic vinyl monomer. As used-herein, a “hydrophilic vinyl monomer” is any siloxane-free (i.e., contains no Si—O groups) hydrophilic monomer having a polymerizable carbon-carbon double bond (i.e., a vinyl group) present in its molecular structure that is not part of an acryl group, where the carbon-carbon double bond of the vinyl group is less reactive than the carbon-carbon double bond present in a polymerizable methacrylate group under free radical polymerization. As used herein, the term “acryl group” refers to the polymerizable group present in acrylate, methacrylates, acrylamides, etc. Thus, while carbon-carbon double bonds are present in acrylate and methacrylate groups, as used herein, such polymerizable groups are not considered to be vinyl groups. Further, as used herein, a monomer is “hydrophilic” if at least 50 grams of the monomer are fully soluble in 1 liter of water at 20° C. (i.e., ˜ 5% soluble in water) as determined visibly using a standard shake flask method. In various examples, the hydrophilic vinyl monomer is N-vinyl-N-methylacetamide (VMA), or N-vinyl pyrrolidone (NVP), or 1,4-butanediol vinyl ether (BVE), or ethylene glycol vinyl ether (EGVE), or diethylene glycol vinyl ether (DEGVE), or any combination thereof. In one example, the polymerizable composition comprises at least 10 wt. %, 15 wt. %, 20 wt. %, or 25 wt. % up to about 45 wt. %, 60 wt. %, or 75 wt. % of a hydrophilic vinyl monomer. As used herein, a given weight percentage of a particular class of component (e.g., hydrophilic vinyl monomer, siloxane monomer, or the like) in the polymerizable composition equals the sum of the wt. % of each ingredient in the composition that falls within the class. Thus, for example, a polymerizable composition that comprises 5 wt. % BVE and 25 wt. % NVP and no other hydrophilic vinyl monomer, is said to comprise 30 wt. % hydrophilic vinyl monomer. In one example, the hydrophilic vinyl monomer is a vinyl amide monomer. Exemplary hydrophilic vinyl amide monomers are VMA and NVP. In a specific example, the polymerizable composition comprises at least 25 wt. % of a vinyl amide monomer. In a further specific example, the polymerizable composition comprises from about 25 wt. % up to about 75 wt. % of VMA or NVP, or a combination thereof. Additional hydrophilic monomers that may be included in the polymerizable composition are N,N-dimethylacrylamide (DMA), 2-hydroxyethyl methacrylate (HEMA), ethoxyethyl methacrylamide (EOEMA), ethylene glycol methyl ether methacrylate (EGMA), and combinations thereof.

As an option, one or more non-silicone containing hydrophobic monomers can be present as part of the polymerizable composition. A hydrophobic monomer can be understood to be any monomer for which 50 grams of the monomer are not visibly fully soluble in 1 liter of water at 20° C. using a standard shake flask method. Examples of suitable hydrophobic monomers include methyl acrylate, or ethyl acrylate, or propyl acrylate, or isopropyl acrylate, or cyclohexyl acrylate, or 2-ethylhexyl acrylate, or methyl methacrylate (MMA), or ethyl methacrylate, or propylmethacrylate, or butyl acrylate, or 2-hydroxybutyl methacrylate, or vinyl acetate, or vinyl propionate, or vinyl butyrate, or vinyl valerate, styrene, or chloroprene, or vinyl chloride, or vinylidene chloride, or acrylonitrile, or 1-butene, or butadiene, or methacrylonitrile, or vinyltoluene, or vinyl ethyl ether, or perfluorohexylethylthiocarbonylaminoethyl methacrylate, or isobornyl methacrylate (IBM), or trifluoroethyl methacrylate, or hexafluoroisopropyl methacrylate, or tetrafluoropropyl methacrylate, or hexafluorobutyl methacrylate, or any combinations thereof.

The hydrophobic monomer, if used, can be present in the reaction product of the polymerizable composition in amounts of from 1 wt. % to about 30 wt. %, such as from 1 wt. % to 25 wt. %, from 1 wt. % to 20 wt. %, from 1 wt. % to 15 wt. %, from 2 wt. % to 20 wt. %, from 3 wt. % to 20 wt. %, from 5 wt. % to 20 wt. %, from 5 wt. % to 15 wt. %, from 1 wt. % to 10 wt. %, based on the total weight of the polymerizable composition.

The polymerizable composition may additionally comprise at least one cross-linking agent. As used herein, a “cross-linking agent” is a molecule having at least two polymerizable groups. Thus, a cross-linking agent can react with functional groups on two or more polymer chains so as to bridge one polymer to another. The cross-linking agent may comprise an acryl group or a vinyl group, or both an acryl group and a vinyl group. In certain examples, the cross-linking agent is free of siloxane moieties, i.e., it is a non-siloxane cross-linking agent. A variety of cross-linking agents suitable for use in silicone hydrogel polymerizable compositions are known in the field (see, e.g., U.S. Pat. No. 8,231,218, incorporated herein by reference). Examples of suitable cross-linking agents include, without limitation, lower alkylene glycol di(meth)acrylates such as triethylene glycol dimethacrylate, diethylene glycol dimethacrylate, poly (lower alkylene) glycol di(meth)acrylates and lower alkylene di(meth)acrylates; divinyl ethers such as triethyleneglycol divinyl ether, diethyleneglycol divinyl ether, 1,4-butanediol divinyl ether and 1,4-cyclohexanedimethanol divinyl ether; divinyl sulfone; di- and trivinylbenzene; trimethylolpropane tri(meth)acrylate; pentaerythritol tetra(meth)acrylate; bisphenol A di(meth)acrylate; methylenebis(meth)acrylamide; triallyl 1,3-bis(3-phthalate; methacryloxypropyl)tetramethyldisiloxane; diallyl phthalate; and combinations thereof.

As will be appreciated by those skilled in the art, the polymerizable composition may comprise additional polymerizable or non-polymerizable ingredients conventionally used in contact lens formulations such as one or more of a polymerization initiator, a UV absorbing agent, a tinting agent, an oxygen scavenger, and/or a chain transfer agent, or the like.

In one example, the polymerizable composition for the silicone hydrogel contains no hydroxyalkyl cellulose. Consequently, the resulting contact lens contains no hydroxyalkyl cellulose prior to being immersed in the packaging solution.

In some examples, the polymerizable composition may include an organic diluent in an amount to prevent or minimize phase separation between the hydrophilic and hydrophobic components of the polymerizable composition, so that an optically clear lens is obtained. Diluents commonly used in contact lens formulations include propanol, hexanol, ethanol, and/or other primary, secondary or tertiary alcohols. In other examples, the polymerizable composition is free or substantially free (e.g., less than 100 ppm) of an organic diluent. In such examples, the use of siloxane monomers containing hydrophilic moieties such as polyethylene oxide groups, pendant hydroxyl groups, or other hydrophilic groups, may make it unnecessary to include a diluent in the polymerizable composition.

In one example, the polymerizable composition for the silicone hydrogel is substantially free of hydrophilic siloxane monomers. A polymerizable composition for a silicone hydrogel is considered substantially free of hydrophilic siloxane monomers if less than 1.0 wt. % of the polymerizable composition comprises hydrophilic siloxanes. Stated conversely, in one example, at least 99 wt. % of all of the siloxane monomers used in the polymerizable composition for the contact lens of the invention are free of hydrophilic siloxane monomers. Such siloxanes are referred to herein as “hydrophobic siloxanes.” Examples of hydrophobic siloxanes include mono-methacryloxypropyl functional polydimethylsiloxanes, styrylethyltris(trimethylsiloxy)silane, methacryloxypropyl terminated polydimethylsiloxanes, and methacryloxypropyltris(trimethylsiloxy)silane.

In a specific example, the silicone hydrogel is made from a polymerizable composition comprising at least 10 wt. % methacryloxypropyltris(trimethylsiloxy)silane. In one example, the polymerizable composition comprises at least 10 wt. % of a mono-methacryloxypropyl functional polydimethylsiloxane (PDMS) or a methacryloxypropyl terminated PDMS, or both a mono-methacryloxypropyl functional PDMS and a methacryloxypropyl terminated PDMS. Somofilcon A is one example of a silicone hydrogel in which all siloxanes used in the polymerizable composition are hydrophobic siloxanes. Specifically, the hydrophobic siloxanes in the polymerizable composition for somofilcon A are methacryloxypropyltris(trimethylsiloxy)silane, a mono-methacryloxypropyl functional polydimethylsiloxane, and a methacryloxypropyl terminated polydimethylsiloxanes (i.e. a bi-functional PDMS). In one example, the silicone hydrogel is somofilcon A.

In one example, the silicone hydrogel contact lens of the present invention is made from a polymerizable composition comprising from 20 wt. % to 55 wt. % of siloxane monomer(s), from 30 wt. % to 55 wt. % of a vinyl monomer selected from NVP, VMA, or combinations thereof, and optionally from about 1 wt. % to about 20 wt. % of a hydrophilic monomer selected from N,N-dimethylacrylamide (DMA), 2-hydroxyethyl methacrylate (HEMA), ethoxyethyl methacrylamide (EOEMA), or ethylene glycol methyl ether methacrylate (EGMA), or any combination thereof, and optionally from about 1 wt. % to about 20 wt. % of a hydrophobic monomer selected from methyl methacrylate (MMA), isobornyl methacrylate (IBM), or 2-hydroxybutyl methacrylate (HOB) or any combination thereof. Silicone hydrogel materials made from this specific embodiment of polymerizable composition include stenfilcon A, and somofilcon A.

In a further example, the above-described polymerizable composition comprises the siloxanes of stenfilcon A, specifically a first siloxane having the structure represented by Formula (I),

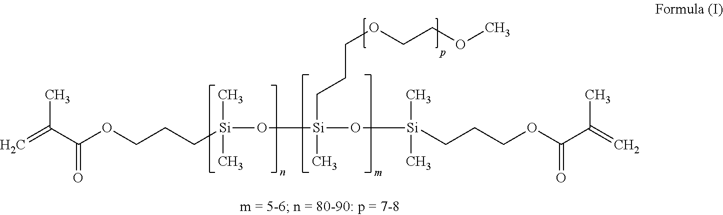

and a second siloxane having the structure represented by Formula (II),

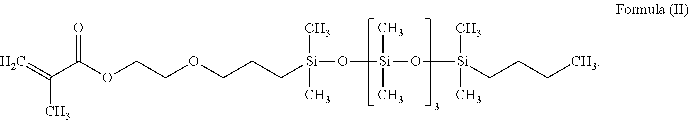

Conventional methods can be used to manufacture the contact lens of the present invention. As an example, a polymerizable composition for a silicone hydrogel composition is dispensed into a female mold member having a concave surface that defines the front surface of the contact lens. A male mold member having a convex surface that defines the back surface of the contact lens, i.e., the cornea-contacting surface, is combined with the female mold member to form a contact lens mold assembly that is subjected to curing conditions, such as UV or thermal curing conditions, under which the curable composition is formed into a polymeric lens body. The mold assembly is disassembled (i.e., demolded) and the polymeric lens body is removed from the mold and contacted with a solvent to remove (i.e. extract) unreacted components from the lens body and/or hydrate the lens body. If an organic solvent is used for extraction, the lens body is hydrated in one or more hydration liquids such as water or an aqueous solution and packaged. Exemplary methods of manufacturing silicone hydrogel contact lenses are described in U.S. Pat. Nos. 8,865,789 and 8,703,891.

The hydrated silicone hydrogel contact lens and the above-described packaging solution comprising HEC or HPMC are sealed in a contact lens package. Any container suitable for sealing and autoclaving a contact lens and an amount of packaging solution sufficient to completely cover the contact lens, typically about 0.5-1.8 ml, may be used. In one example, the contact lens package can include or comprise a plastic base member comprising a cavity configured to retain the contact lens and packaging solution and a cover that forms a liquid-tight seal with the base member. In one example, the base member comprises a flange region extending outwardly around the cavity. In such example, the cover may comprise a removable foil which is attached to the flange region in a manner to provide a liquid-impermeable sealed contact lens package, such as by heat sealing or gluing. Such contact lens packages, which are commonly referred to as “blister packs”, are well-known in the art (see e.g., U.S. Pat. No. 7,426,993).

The method of manufacturing the sealed contact lens package of the present invention further comprises sterilizing the contact lens by autoclaving the sealed contact lens package at conditions comprising a temperature of at least 120° C. for at least 15 minutes at a pressure of at least 15 psi. Typical conditions for autoclaving contact lens packages comprise a temperature of 121° C., a pressure of 17 psi, and a time of 30 minutes.

As previously described, the contact lens of the present invention absorbs an amount of the hydroxyalkyl cellulose from the packaging solution during autoclaving. In order to determine the amount of hydroxyalkyl cellulose that is absorbed by the contact lens, the autoclaved contact lens is removed from its package and extracted in ethanol using the method described in Example 5 below. The amount of hydroxyalkyl cellulose present in the extract, i.e. the “extractable amount” is measured by HPLC as described in Example 5, and corresponds to the amount of hydroxyalkyl cellulose that is absorbed by the silicone hydrogel during autoclave. In one example, the extractable amount of the hydroxyalkyl cellulose per lens embedded in the silicone hydrogel is at least 25 μg, or at least 50 μg, or at least 75 μg, or at least 100 μg.

The improvement in wettability of the contact lens, as mentioned herein, can be determined based on a measurement of the sessile drop contact angle, as described herein, wherein a lower sessile drop contact angle (in degrees) means better wettability.

For purposes of the present invention, the term “embedded” is used to described the physical presence of the hydroxyalkyl cellulose in the silicone hydrogel. The “embedding” of the hydroxyalkyl cellulose encompasses or includes any physical attachment or trapping of the hydroxyalkyl cellulose in the silicone hydrogel. As indicated, one specific example of “embedding” is the absorption of the hydroxyalkyl cellulose by the silicone hydrogel. The “embedding” of the hydroxyalkyl cellulose in the silicone hydrogel further includes the property that at least a portion of the embedded hydroxyalkyl cellulose is extractable such as with the use of a solvent as described above.

The hydroxyalkyl cellulose embedded in (e.g., absorbed by) the contact lens can be embedded homogenously throughout the contact lens or non-homogenously throughout the contact lens or can be more concentrated at the exposed surfaces of the contact lens (e.g., the convex and/or concave surface of the contact lens). For instance, the hydroxyalkyl cellulose can be present in higher concentrations at a surface or near the surface (e.g. within 10% or within 5% or within 1% of a surface based on the average thickness of the contact lens). As a further examples, at least 75 wt % or at least 85 wt % or at least 95 wt % (based on the total wt % of hydroxyalkyl cellulose present in the contact lens) can be located at a surface and/or near the surface of the contact lens. The hydroxyalkyl cellulose can present in amounts such that a gradient of concentrations are formed, wherein the highest concentrations of the hydroxyalkyl cellulose are present at and/or near the surface and lower concentrations of the hydroxyalkyl cellulose are further away from the surface and/or further away from the ‘near surface’. The hydroxyalkyl cellulose can be present as regions of hydroxyalkyl cellulose uniformly or randomly distributed in the contact lens.

The hydroxyalkyl cellulose embedded in the contact lens can be present as individual molecules of hydroxyalkyl cellulose distributed in the contact lens or can be agglomerates distributed in the contact lens.

The present invention further includes a contact lens with at least a portion of the contact lens having absorbed amount of at least one hydroxyalkyl cellulose. The contact lens can optionally be immersed in a packaging solution. The contact lens can comprise a silicone hydrogel. The chemistry of the contact lens can be as described herein.

The present invention further includes a contact lens package comprising (a) a packaging solution comprising a hydroxyalkyl cellulose and optionally at least one surfactant, and (b) a contact lens immersed in the packaging solution, wherein the contact lens comprises a silicone hydrogel and an extractable amount of the hydroxyalkyl cellulose embedded in the silicone hydrogel, wherein the contact lens package is subjected to a heat treatment that is not considered autoclaving but yet achieves the absorption of the hydroxyalkyl cellulose by the contact lens. The other optional components and/or steps described earlier can be utilized here as one or more options (e.g., the use of at least one surfactant in the solution).

The present invention further includes a method to embed (e.g., absorb) at least a portion of a hydroxyalkyl cellulose to a contact lens, wherein the method comprises placing the contact lens in a solution that comprises at least the hydroxyalkyl cellulose and subjecting the contact lens and solution to conditions that cause at least a portion of the hydroxyalkyl cellulose to be absorbed or embedded into the contact lens. The solution utilized can optionally be utilized as a packaging solution or as part of a packaging solution or the contact lens with embedded hydroxyalkyl cellulose can be packaged in a different solution that may or may not contain any hydroxyalkyl cellulose. The other optional components and/or steps described earlier can be utilized here as one or more options (e.g., the use of at least one surfactant in the solution).

The present invention further relates to a method to improve the wettability of a silicone hydrogel contact lens, wherein the method comprises embedding (e.g., absorbing) at least one hydroxyalkyl cellulose into the silicone hydrogel. The method can further involve placing the contact lens in a solution that comprises at least the hydroxyalkyl cellulose and subjecting the contact lens and solution to conditions that cause at least a portion of the hydroxyalkyl cellulose to be absorbed or embedded into the contact lens. The solution utilized can optionally be utilized as a packaging solution or as part of a packaging solution or the contact lens with embedded hydroxyalkyl cellulose can be packaged in a different solution that may or may not contain any hydroxyalkyl cellulose. The other optional components and/or steps described earlier can be utilized here as one or more options (e.g., the use of at least one surfactant in the solution).

The present invention further relates to a method to decrease the sessile drop contact angle of a silicone hydrogel contact lens, wherein the method comprises embedding (e.g., absorbing) at least one hydroxyalkyl cellulose into the silicone hydrogel. The method can further involve placing the contact lens in a solution that comprises at least the hydroxyalkyl cellulose and subjecting the contact lens and solution to conditions that cause at least a portion of the hydroxyalkyl cellulose to be absorbed by or embedded into the silicone hydrogel contact lens. The solution utilized can optionally be utilized as a packaging solution or as part of a packaging solution or the contact lens with embedded hydroxyalkyl cellulose can be packaged in a different solution that may or may not contain any hydroxyalkyl cellulose. The other optional components and/or steps described earlier can be utilized here as one or more options (e.g., the use of at least one surfactant in the solution). The amount of decrease of the sessile contact angle (comparing before and after the method of treatment to the contact lens) can be as described herein (e.g., a decrease of at least 5%, at least 10%, at least 15%, at least 20%, such as from 1% to 30% or 5% to 30%).

The following Examples illustrate certain aspects and advantages of the present invention, which should be understood not to be limited thereby.

### Example 1

A phosphate buffered saline packaging solution (a “Control”), referred herein as “PB2”, was prepared by mixing together the ingredients and amounts shown in Table 1. A PB2 solution with 0.5 wt % hydroxyethyl cellulose (HEC) having an average molecular weight of 380 kDa was also prepared (“Test” solution Table 1).

TABLE 1

Parts by weight

| Component | PB2 | Test |
|---|---|---|
| Sodium dihydrogen phosphate dihydrate | 0.07% | 0.07% |
| Sodium hydrogen phosphate dodecahydrate | 0.60% | 0.60% |
| Sodium Chloride | 0.83% | 0.83% |
| Poloxamer 407 | 0.02% | 0.02% |
| Hydroxyethyl cellulose (380 kDa) | — | 0.50% |
| Purified H₂O | 98.48% | 97.98% |

The viscosity of the packaging solutions of Examples 1 through 4 was determined using a Brookfield Viscometer Model DV-I+. Measurements were taken at 25° C. using the Small Sample Adaptor (SSA), spindle SC4-18 and an rpm of 100. The viscosity of the PB2 and Test solutions of Table 1 were 1.3 cP and 7.8 cP, respectively.

Contact lenses were made by curing the polymerizable composition for somofilcon A. Each cured lens was removed from a mold, hydrated with purified water, and placed in a blister package together with 1.1 mL of Test or Control packaging solution. The packages were sealed and autoclaved. The post-autoclave (post-AC) viscosity of each packaging solution was measured. Surprisingly, the viscosity of the packaging solution containing 0.5% HEC dropped over 50% to 3.8 cP. To determine whether the drop in viscosity was due to degradation of the HEC during autoclave independent of the presence of the contact lens 1.1 mL of the Test solution was placed in a blister package without a contact lens and autoclaved. The results, which are summarized in Table 2, show that there was only about a 5% drop in the viscosity of the Test solution after autoclave in the absence of the contact lens.

TABLE 2

Packaging Solution Viscosity (cP)

Post-AC

| Packaging Solution | Pre-AC | No lenses | With lenses |
|---|---|---|---|
| Control | 1.3 ± 0.0 | N/A | 1.3 ± 0.0 |
| Test | 7.8 ± 0.2 | 7.4 ± 0.1 | 3.8 ± 0.1 |

### Example 2

Somofilcon A contact lenses were pre-conditioned by soaking them in PB2 with 0.5 wt % HEC having an average molecular weight of 380 kDa for 2 hours or 24 hours prior to packaging and autoclaving them in blister packages containing fresh PB2 with 0.5 wt % HEC having average molecular weight of 380 kDa. The viscosity of the packaging solutions pre- and post-autoclave (AC) were measured. Results are shown in Table 3. The packaging solutions of lenses that are presoaked in PB2+HEC prior to autoclave in fresh PB2+HEC have higher viscosity than the packaging solution of lenses that are not presoaked in PB2+HEC, suggesting that the lens material absorbs HEC during pre-conditioning and consequently takes up less HEC during autoclave than lenses that are not pre-conditioned.

TABLE 3

| Pre-condition | Packaging Solution Viscosity (cP) | | Post-AC |
|---|---|---|---|
| time | Pre-AC | Post-AC | % Decrease |
| None | 7.6 ± 0.1 | 3.6 ± 0.0 | 53% |
| 2 hours | | 4.1 ± 0.0 | 46% |
| 24 hours | | 5.8 ± 0.1 | 33% |

### Example 3

To determine whether the type of contact lens material can affect the post-autoclave viscosity of an HEC-containing packaging solution, the experiment described in Example 1 was repeated using contact lenses made from somofilcon A and omafilcon A, which is a conventional, non-silicone hydrogel contact lens material. The results are shown in Table 4. The viscosity of the packaging solution that was autoclaved with the contact lens made from omafilcon A was about 13% less than that of the pre-autoclave packaging solution, whereas the viscosity of the packaging solution that was autoclaved with the contact lens made from somofilcon A was about 46% less than that of the pre-autoclave packaging solution.

TABLE 4

| | 0.5% HEC 380 kDa Packaging | | |
|---|---|---|---|
| | Solution Viscosity (cP) | | Post-AC Viscosity |
| Lens Material | Pre-AC | Post-AC | Decrease |
| Omafilcon A | 7.6 ± 0.1 | 6.6 ± 0.1 | 13% |
| Somofilcon A | | 4.1 ± 0.1 | 46% |

### Example 4

HEC-containing PB2 packaging solutions were made with varying concentrations and molecular weights of HEC. The pre-autoclave (pre-AC) viscosity of each packaging solution was measured. The packaging solutions were autoclaved in contact lens blisters with and without a contact lens made from somofilcon A and post-autoclave (post-AC) viscosities were measured. The results are shown in Table 5.

TABLE 5

| wt | HEC | Pre-AC | Post-AC Viscosity (cP) | | Viscosity |
|---|---|---|---|---|---|
| % | Mol. | Viscosity | Without | With | Decrease |
| HEC | Wt. | (cP) | lenses | lenses | with lenses |
| 0.75 | 380 kDa | 17.2 ± 1.0 | 16.8 ± 0.5 | 6.7 ± 0.1 | 61% |
| 0.5 | 380 kDa | 7.8 ± 0.2 | 7.7 ± 0.2 | 3.8 ± 0.2 | 51% |
| 0.3 | 380 kDa | 3.8 ± 0.0 | 3.5 ± 0.2 | 2.4 (single | 37% |
| | | | | data point) | |
| 0.24 | 720 kDa | 7.6 ± 0.1 | 5.7 ± 0.1 | 2.8 ± 0.0 | 63% |
| 0.12 | 720 kDa | 3.2 ± 0.0 | 2.8 ± 0.0 | 2.0 ± 0.0 | 38% |

### Example 5

Contact lenses made from somofilcon A, stenfilcon A, comfilcon A, and omafilcon A were autoclaved in the test and control packaging solutions of Example 1. The post-autoclave (AC) viscosity of the packaging solution for each lens (n=3) was determined at 25° C. (1 atm) and shear rate=10 [1/s] using a Physica MCR 301 model rheometer from Anton Paar. The results are in Table 6. The pre-autoclave viscosity was about 7.6 cP.

A KRÜSS DSA 100 instrument was used to measure the sessile drop contact angle of each lens (n=5). The lenses were stored at room temperature for at least 24 hours at room temperature after autoclaving. Each lens was removed from its blister with tweezers and the lens edge was placed on a dust-free tissue to remove excess solution. The lens was then placed front face down on dry tissue and the residual water on the lens surface was removed by gently circling the lens's inner part with silicone tweezers. The lens was then moved to a new dry location on the tissue. The blotted lens was then carefully center positioned on a convex mold, and the mold was mounded within the DSA 100 chamber. The needle was positioned as close as possible to the lens center. A 2 μL PBS droplet was dispensed from the needle (Drop dispense rate: <450 μL/min) and lowered until it touched the lens surface, the needle was quickly raised. The contact angle was measured at room temperature. All measurements were conducted within 30 seconds of lens blotting. As shown in Table 6, the contact angles of the contact lenses made from somofilcon A and stenfilcon A decreased when autoclaved in HEC packaging solution compared to the Control packaging solution, whereas the contact angles of the contact lenses made from comfilcon A and omafilcon A both increased when autoclaved in HEC packaging solution.

The amount of HEC in each lens was determined by extracting the lens with ethanol and measuring HEC in the extract by HPLC. Briefly, lenses were autoclaved and stored at room temperature for at least 24 hours before testing. After removing a lens from its blister and blotting it on a dust-free tissue, the lens was immersed and rinsed in 2 mL deionized water for 30 seconds to remove residual packaging solution. This rinse process was repeated three times in total. Subsequently, the lens placed in a 5 mL glass vial and immersed in 3 mL ethanol for 24 hours at room temperature with gentle shaking to extract the hydroxyethyl cellulose (HEC). Following ethanol evaporation, the HEC extract was redissolved in 1 mL deionized water and filtered before HPLC analysis. HPLC analysis was performed using an EPROGEN CCS201-25 CATSEC100 5u 250×4.6 column with an EPROGEN CCS210-3 CATSEC1000 7u 33×4.6 guard column. A mobile phase of 0.2M NaCl and 0.1% TFA was employed at a flow rate of 0.2 mL/min and a temperature of 30° C. Refractive index detection was used for analysis, with a run time of 35 minutes and an injection volume of 50 μL. The results are in Table 6.

TABLE 6

| | | | | | | HEC |
|---|---|---|---|---|---|---|
| | | Post-AC | Post-AC | Sessile Drop | Contact | amount |
| Lens | Packaging | viscosity | Viscosity | Contact | Angle | (μg/lens, |
| material | solution | (cP) | Decrease | Angle (°) | % Δ | n = 4) |
| Somofilcon | Test | 4.1 ± 0.7 | 46% | 22.1 ± 2.1 | 22% | 206 ± 9 |
| A | Control | 0.98 | | 28.3 ± 3.3 | decrease | — |
| Stenfilcon | Test | 5.5 ± 0.1 | 28% | 28.8 ± 1.9 | 14% | 122 ± 15 |
| A | Control | 0.9 ± 0.1 | | 33.3 ± 3.4 | decrease | — |
| Comfilcon | Test | 5.6 ± 0.1 | 26% | 17.2 ± 0.5 | 25% | 91 ± 5 |
| A | Control | 1.0 ± 0.0 | | 13.8 ± 0.6 | increase | — |
| Omafilcon | Test | 5.9 ± 0.1 | 22% | 37.7 ± 1.2 | 15% | 47 ± 3 |
| A | Control | 1.2 ± 0.2 | | 32.9 ± 1.6 | increase | — |

### Example 6

The effect of surfactant on pre- and post-autoclave viscosities was evaluated by repeating Example 1 and including a sample in which the packaging solution contained no surfactant. The results are shown in Table 7, in which PB2+HEC packaging solution is the same as for Example 1 (i.e. the packaging solution was PB2 with 0.5% HEC 380 kDa) and PBS+HEC packaging solution is the same as PB2 except that Poloxamer was not included in the solution. The results show that the inclusion of surfactant in the packaging solution decreases the post-autoclave viscosity, suggesting that the presence of surfactant in the packaging solution leads to greater HEC uptake by the lens material.

TABLE 7

| | Pre-AC viscosity | Post-AC viscosity |
|---|---|---|
| Condition | (cP, n = 3) | (cP, n = 3) |
| PB2 + HEC + lens | 7.5 ± 0.0 | 4.1 ± 0.7 |
| PB2 + HEC (no lens) | 7.2 ± 0.3 | 6.2 ± 0.1 |
| PBS + HEC + lens | 7.4 ± 0.1 | 5.8 ± 0.0 |

The disclosure herein refers to certain illustrated examples, it is to be understood that these examples are presented by way of example and not by way of limitation. The intent of the foregoing detailed description, although discussing exemplary examples, is to be construed to cover all modifications, alternatives, and equivalents of the examples as may fall within the spirit and scope of the invention as defined by the additional disclosure.

References herein to “an example” or “a specific example” or “an aspect” or “an embodiment” or similar phrase, are intended to introduce a feature or features of the contact lens or components thereof, the sealed contact lens package or components thereof, or method of manufacturing the contact lens (depending on context) that can be combined with any combination of previously-described or subsequently-described examples, aspects, embodiments (i.e. features), unless a particular combination of features is mutually exclusive, or if context indicates otherwise. Further, as used in this specification, the singular forms “a,” “an,” and “the” include plural referents (e.g., at least one or more) unless the context clearly dictates otherwise. Thus, for example, reference to a “contact lens” includes a single lens as well as two or more of the same or different lenses.

The entire contents of all cited references in this disclosure, to the extent that they are not inconsistent with the present disclosure, are incorporated herein by reference.

The present invention can include any combination of the various features or embodiments described above and/or in the claims below as set forth in sentences and/or paragraphs. Any combination of disclosed features herein is considered part of the present invention, and no limitation is intended with respect to combinable features.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. An autoclaved packaged contact lens comprising: (a) a packaging solution comprising a hydroxyalkyl cellulose, and (b) a contact lens immersed in the packaging solution, wherein the contact lens comprises a silicone hydrogel and an extractable amount of the hydroxyalkyl cellulose embedded in the silicone hydrogel.

2. The autoclaved packaged contact lens of claim 1, wherein the hydroxyalkyl cellulose is selected from hydroxyethyl cellulose, hydroxypropyl methylcellulose, hydroxypropyl cellulose, ethyl hydroxyethyl cellulose, methyl ethyl hydroxyethyl cellulose, and combinations thereof.

3. The autoclaved packaged contact lens of claim 1, wherein the packaging solution further comprises a surfactant.

4. The autoclaved packaged contact lens of claim 1, wherein the contact lens has a sessile drop contact angle that is equal to or lower than the sessile drop contact angle of a control lens that is autoclaved in a control packaging solution that lacks the hydroxyalkyl cellulose.

5. The autoclaved packaged contact lens of claim 1, wherein the extractable amount of the hydroxyalkyl cellulose is at least 50 μg.

6. The autoclaved packaged contact lens of claim 1, wherein the packaging solution has a post-autoclave viscosity of at least 2.0 cP.

7. The autoclaved packaged contact lens of claim 1, wherein the packaging solution has a pre-autoclave viscosity that is at least 20% greater than the post-autoclave viscosity.

8. The autoclaved packaged contact lens of claim 1, wherein the packaging solution comprises from about 0.1 wt. % to about 1.0 wt. % of HEC.

9. The autoclaved packaged contact lens of claim 1, wherein the hydroxyalkyl cellulose is HEC having an average molecular weight of about 100 kDa to 1200 kDa.

10. The autoclaved packaged contact lens of claim 1, wherein the packaging solution comprises HEC having an average molecular weight of about 250 kDa to 750 kDa.

11. The autoclaved packaged contact lens of claim 1, wherein the contact lens has a sessile drop contact angle that is at least 10% lower than the sessile drop contact angle of a control lens packaged and autoclaved in a packaging solution that lacks the hydroxyalkyl cellulose.

12. The autoclaved packaged contact lens of claim 1, wherein the surfactant is a poloxamer.

13. The autoclaved packaged contact lens of claim 1, wherein the silicone hydrogel is a reaction product of a polymerizable composition that is substantially free of hydrophilic siloxane monomers.

14. The autoclaved packaged contact lens of claim 1, wherein the packaging solution consists essentially of a buffered saline solution, the surfactant, and the hydroxyalkyl cellulose.

15. The autoclaved packaged contact lens of claim 1, wherein the silicone hydrogel is a reaction product of a polymerizable composition comprising a bis(trimethylsiloxy)silane monomer or a tris(trimethylsiloxy)silane monomer, or a combination thereof.

16. The autoclaved packaged contact lens of claim 1, wherein the silicone hydrogel is a reaction product of a polymerizable composition that comprises at least 10% (wt/wt) methacryloxypropyltris(trimethylsiloxy)silane.

17. The autoclaved packaged contact lens of claim 1, wherein the silicone hydrogel is a reaction product of a polymerizable composition that comprises at least 10% (wt/wt) of a polydimethylsiloxane monomer.

18. The autoclaved packaged contact lens of claim 1, wherein the silicone hydrogel is a reaction product of a polymerizable composition that comprises from about 25 wt. % up to about 75 wt. % of VMA or NVP, or a combination thereof.

19. The autoclaved packaged contact lens of claim 1, wherein the contact lens contains no hydroxyalkyl cellulose prior to being immersed in the packaging solution.

20. The autoclaved packaged contact lens of claim 1, wherein the package comprises: a base member having a cavity that retains the packaging solution and the contact lens; and a cover that forms a liquid-tight seal with the base member.
